(19) United States
(12) Patent Application Publication
(10) Pub. No.: US 2013/0323445 A1
(43) Pub. Date: Dec. 5, 2013

(54) Water-Soluble Product

(71) Applicants: Carson K. Winget, Saint George, UT (US); Kenny D. Lewis, Saint George, UT (US)

(72) Inventors: Carson K. Winget, Saint George, UT (US); Kenny D. Lewis, Saint George, UT (US)

(21) Appl. No.: 13/894,564

(22) Filed: May 15, 2013

Related U.S. Application Data
(63) Continuation-in-part of application No. 13/531,963, filed on Jun. 25, 2012, now Pat. No. 8,455,567.
Application No. 13/531,963 is a continuation of application No. 12/979,853, filed on Dec. 28, 2010, now Pat. No. 8,227,523.

(51) Int. Cl. C08K 3/26; C08K 5/56; C08K 3/40; C08K 3/34

(52) U.S. Cl. CPC C08K 3/26; C08K 3/34; C08K 5/56; C08K 3/40
USPC 428/34.5; 524/377; 524/249; 428/36.92

(57) ABSTRACT

Compositions and articles comprising rapidly-degrading materials are provided as are methods of making articles using compositions of the invention. The articles and compositions include polyvinyl alcohol and one or more stiffeners.

### CROSS-REFERENCE TO PRIOR APPLICATIONS

This application is a continuation-in-part of U.S. patent application Ser. No. 13/531,963 by Winget et al. entitled “Water Soluble Product,” filed Jun. 25, 2013, now U.S. Pat. No. ______, which is a continuation of U.S. patent application Ser. No. 12/979,853 by Winget et al. entitled “Water Soluble Product,” filed Dec. 28, 2010, now U.S. Pat. No. 8,227,523. The entire disclosure of both of these cases is hereby incorporated by reference for all purposes.

### FIELD OF THE INVENTION

The present invention relates to articles and compositions that break down rapidly in the environment.

### BACKGROUND

Many disposable products are made from materials—particularly plastics—which degrade slowly in the outdoor environment. Such products are typically only used once or a handful of times before disposal, but they persist in the outdoor environment for long periods of time, creating physical and health hazards for humans and animals and visually blighting the landscape. The scope of the environmental problem caused by plastic waste alone is immense: in Europe alone, nearly 24 million tons of post-consumer plastic waste was produced in 2008. See BIO Intelligence Service, PLASTIC WASTE IN THE ENVIRONMENT: REVISED FINAL REPORT; April, 2011. Of this waste, less than one quarter was recycled, with a large fraction of the remainder entering the environment. So much post-consumer plastic waste has been discharged that vast “Garbage Patches” comprising unrecycled post-consumer waste have developed in the Pacific Ocean. (See, e.g. http://http://marinedebris.noaa.gov/info/pdf/patch.pdf.) While disposable plastic products are essential to modern life, there is an obvious need to reduce their adverse environmental impacts.

### SUMMARY OF THE INVENTION

The present invention addresses this need by providing plastics that degrade rapidly in the environment, as well as articles comprising plastics of the invention and methods for making the same.

In one aspect, the present invention provides a composition that is useful for the manufacture of consumer products and other articles. The composition comprises one or more water-soluble plastics including polyvinyl alcohol (PVA) or polyethylene glycol (PEG) and a mixture of stiffening materials. In some embodiments, the stiffening material includes one or more of fiberglass, a titanium complex, talc, or calcium carbonate. The titanium complex can be a lactic acid titanium complex, a triethanolamine titanium complex, a mixture of the two, or a mixture of either or both of the foregoing with fiberglass. The fiberglass used in the articles and compositions can be, in various embodiments, a particle, a fiber, or a mixture of the two. The composition itself can be in the form of a granule, a flexible rod, filament or other solid body suitable for melting molding or otherwise forming into an article, or a mixture comprising solid and liquid components of the composition, either separately, partially mixed, or fully mixed.

In another aspect, the present invention provides an article with at least one solid surface, the article comprising one or more compositions of the present invention. In various embodiments, the article is an outdoor product such as a golf tee, a pellet for a firearm, a tent stake, a survey stake, etc. Alternatively, the article is a container or a portion of a container, for example a clamshell package for a consumer product, a bottle such as a pill bottle, a lid for a bottle, a container for a non-aqueous fluid such as a bottle for oil or detergent, a bucket, a bowl, a barrel, a basin, a food container such as a clamshell box, a plate, a cup, and so on. In other embodiments, the article is a packing material or filler such as a foam pellet, foam peanut, foam sheet or shaped foam packaging support. In still other embodiments, the article is a medical product, such as an absorbent sponge or gauze. Other articles, particularly disposable articles, which incorporate plastic, are also within the scope of the invention.

In yet another aspect, the present invention includes methods of making an article of the present invention. In various embodiments, the article can be formed from a composition of the invention by injection molding, extrusion, blow molding, thermoforming, rotational molding, casting, foaming, compression molding, 3D printing or transfer molding.

### BRIEF DESCRIPTION OF THE DRAWINGS

In the drawings, like reference characters generally refer to the same parts throughout the different views. Drawings are not necessarily to scale, as emphasis is placed on illustration of the principles of the invention.

FIG. 1 is a schematic side view of a golf tee in accordance with an embodiment of the present invention.

FIG. 2 is a schematic perspective view of a golf tee in accordance with an embodiment of the present invention.

### DETAILED DESCRIPTION

The present invention relates to consumer products and other articles that decompose rapidly in the environment. Exemplary compositions and articles of the present invention incorporate a mixture of PVA, PEG and a suitable stiffener. PVA is water soluble and therefore is well suited to degrade rapidly in the environment, but lacks the rigidity necessary for many consumer applications. To overcome this problem, a stiffener or stiffeners are added in amounts sufficient to provide the rigidity necessary for such applications. In preferred embodiments, the stiffener is talc, fiberglass or Tyzor® (E.I. du Pont de Nemours and Co., Wilmington, Del.) or a mixture of fiberglass and Tyzor®. As used herein, “Tyzor®” refers to a triethanolamine titanium complex such as Titanium (IV) (Triethanolamineaminato)Isopropoxide, sold under the trademark Tyzor® TE, or a lactic acid titanium complex such as Dihydrobis(Ammonium Lactato)Titanium sold under the trademark Tyzor® LA, or a mixture of the two. In other embodiments, other stiffeners known in the art may be used, including, but not limited to, calcium carbonate (CaCO₃).

Compositions of the invention are adapted to be formed into articles by commonly-used means, including extrusion, molding (including injection molding, blow molding, rotational molding, compression molding, and transfer molding), thermoforming, casting or foaming.

In certain embodiments, fiberglass is used as a stiffener within articles and compositions of the present invention in amounts up to 50% by mass of the final mixture. Preferably, fiberglass particles are mixed with pellets comprising PVA, PEG and talc prior to forming the product. Fiberglass may be used in compositions of the invention in any suitable shape or combination of shapes, such as fibers of varying length or diameter, or spheres of varying diameter. Where fiberglass is used in a composition of the invention, the composition also preferably includes a sufficient amount of a carrier such as a surfactant, soap, wax, or light oil to permit even distribution and adhesion of the fiberglass particles on the surfaces of the plastic pellets. These compositions are generally formable into articles using any suitable manufacturing process, such as injection molding, extrusion, 3D printing, etc. as described above.

In a first preferred embodiment, the composition, and any article formed from the composition, comprises 68.1% PVA, 12.20% PEG, 9.7% talc, and 10% fiberglass. In a second preferred embodiment, the composition or article comprises 68.7% PVA, 13% PEG, 8.3% talc and 10% fiberglass. In a third preferred embodiment, the composition or article comprises 61% PVA, 11.5% PEG, 7.5% talc, and 20% fiberglass. In a fourth preferred embodiment, the composition or article comprises 68.4% PVA, 12.6% PEG, 9.0% talc, and 10% fiberglass. The invention also includes compositions and articles in which concentrations of the major components (PVA, PEG, and stiffeners) are varied by up to ±1%, up to ±5%, up to ±10, or up to ±20% or more.

In certain embodiments, Tyzor is used as a stiffener in amounts up to 20% by mass of the final mixture. Tyzor® may be too viscous to be added directly and used in injection molding or other forming machines. Thus, in certain embodiments, Tyzor® is diluted by adding 20% rubbing alcohol by mass and the diluted mixture is sprayed into a mixing vessel. The rubbing alcohol is removed from the Tyzor by evaporation, PVA, PEG and talc are added (preferably in particulate form), and the product is formed by injection molding.

In certain embodiments, Tyzor and fiberglass may be used simultaneously. In one embodiment, talc, fiberglass and Tyzor® are all used to stiffen the product, which is formed into an article using an appropriate forming process.

Compositions of PVA, PEG, talc and other stiffeners, when used at temperatures appropriate for injection molding and other forming techniques, are highly viscous and may result in low injection molding yields when manufactured using injection molding machinery. To help increase such yields, certain embodiments of the present invention make use of a hot sprue and a hot runner and utilize a machine temperature of approximately 350°-380° C. during injection molding. Similar temperatures, hot sprues and hot runners, and other features for improving the flowability and/or ease of use of compositions during molding, may also be used in other molding techniques.

Compositions of the invention may also include reagents useful in manufacturing foams. For instance, compositions of the invention may include a blowing agent which reacts to form a gas that can drive the formation of pores and the expansion of the composition into a foam during a forming process. The blowing agent is optionally activated by an environmental condition created during forming: for instance, the blowing agent may be temperature sensitive, and may generate gas as the temperature of the composition is raised in order to flow through a sprue into a mold. Alternatively, a gas may be introduced into a composition before or during the forming of the composition into an article in order to drive the formation of pores and the volume expansion of the composition during forming into a foam article.

Articles of the present invention are made in a variety of forms, and are adapted to decompose rapidly after use. Articles of the invention preferably have solid surfaces and may be hollow, porous or include cavities (in the case of foam), or may be entirely solid (such as sheets, or articles that are moldable into other shapes, for instance filaments for 3D printers). In one embodiment, the product is a golf tee, which may be discarded on a golf course and which will decompose upon exposure to moisture in the soil. In another embodiment, the product is a stake for a tent or other ground-anchored structure, which will decompose in the ground without the need to be removed. Additional embodiments include, without limitation: shot for use in shotguns or bb guns, and survey stakes and survey flags, containers or portions thereof, a clamshell packages, bottles, lids for bottles, containers for non-aqueous fluids such as detergent or oil, buckets, bowls, barrels, basins, food containers, clamshell boxes, plates, cups, packing materials, fillers, foams including foam pellets, foam peanuts, foam sheets, shaped foam packaging supports, medical products including, absorbent sponges, gauze, and 3D printing products such as filaments for 3D printers and articles formed by a 3D printer.

Articles of the present invention possess physical characteristics including stiffness and/or elasticity which can be tailored to specific applications in much the same way as conventional plastics by altering the proportions of components in the compositions from which they are formed. In particular, the ratio of water soluble polymer to stiffening agent can be varied to create articles having a stiffness, Young's modulus, elastic modulus, or other physical characteristic that may be necessary or desirable for a particular application.

Articles of the present invention are capable of decomposing much more rapidly than plastics currently used to manufacture disposable articles. In certain embodiments, the product degrades rapidly upon exposure to water. In one embodiment, the product is at least 70% decomposed within 10 hours of exposure to a water-containing environment. In another embodiment, the product is at least 95% decomposed within 18 hours of exposure to a water-containing environment.

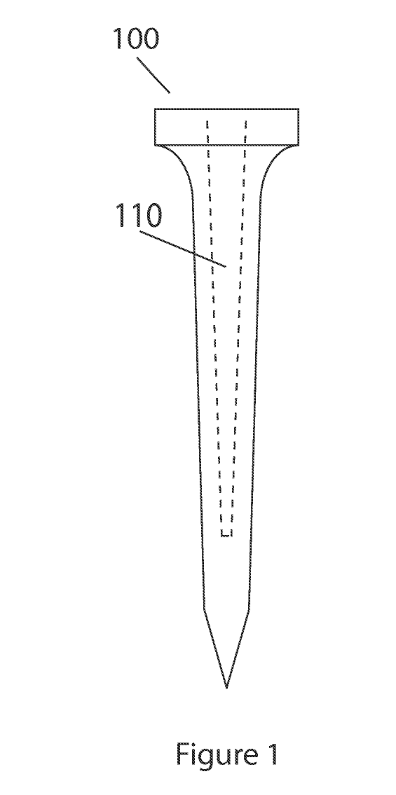

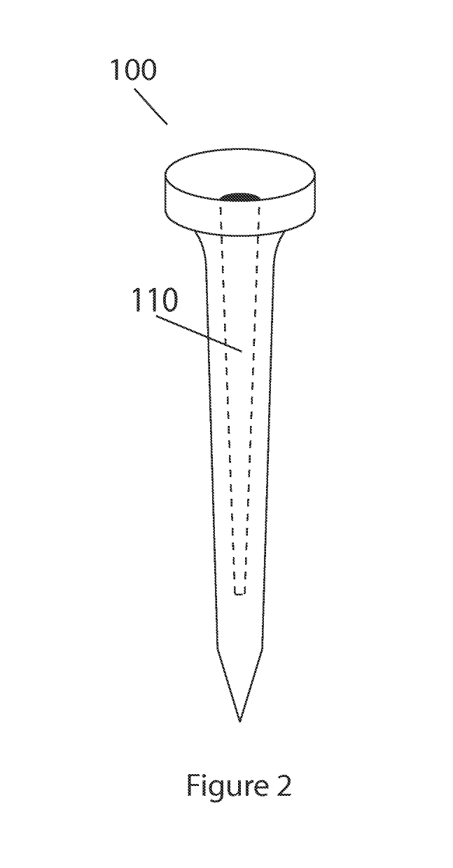

Decomposition is retarded in certain embodiments by applying a coating of a water resistant material such as resin or wax to an exterior surface of the article. In other embodiments, decomposition is accelerated by increasing the surface area of the article relative to its volume. In certain embodiments, the article incorporates crenellations, folds, dimples, bumps, ridges, holes or other structural features to increase the surface area of the product relative to its volume. For example, in the embodiment illustrated in FIGS. 1-2, a golf tee 100 incorporates a bore-hole 110 through the shaft of the tee to increase the surface area of the tee which may be exposed to water. In some embodiments, articles of the present invention may include outer surfaces which are relatively hydrophobic and/or impermeable to water, while also possessing internal features to maximize the area of internal surfaces such as cavities or pores. Such articles can be used over long intervals without danger of unwanted degradation, however when disposed of, the articles can be broken, crushed or their outer surfaces perforated in order to permit water to penetrate the articles and contact their internal surfaces, driving the rapid decomposition of the articles after they are discarded.

The phrase “and/or,” as used herein should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The term “consists essentially of” means excluding other materials that contribute to function, unless otherwise defined herein. Nonetheless, such other materials may be present, collectively or individually, in trace amounts.

As used in herein, the terms “about,” “approximately,” “roughly” and “substantially” are used in this specification and the claims that follow to describe formulations in which a given concentration varies from a recited value by up to ±10%, and in some embodiments ±5% (e.g., by weight or by volume). Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

The term “solid surface,” as used herein to describe a feature of an article, means a surface that is a solid or a glass, or a surface that is characterized by a stiffness sufficient to prevent deformation of the surface under its own weight during a period of use of the article, or a portion of an article which portion has a Young's modulus.

Variations, modifications, and other implementations of what is described herein will occur to those of ordinary skill in the art without departing from the sprit and scope of the invention as claimed. Accordingly, the invention is to be defined not by the preceding illustrative description, but instead by the spirit and scope of the following claims:

What is claimed is:

1. An article having a solid surface, the article comprising:
polyvinyl alcohol;
polyethylene glycol; and
a stiffener comprising one or more of talc, fiberglass, calcium carbonate, and a titanium complex.

2. The article of claim 1, wherein the titanium complex is a lactic acid titanium complex, a triethanolamine titanium complex, or a mixture of the two.

3. The article of claim 1, wherein the article is a disposable consumer article.

4. The article of claim 3, wherein the article is a bottle, a package, a packing material, a container, or a component thereof.

5. The article of claim 1, wherein the article is selected from the group consisting of a golf tee, a pellet for a firearm, a tent stake, a survey stake, a container, a portion of a container, a clamshell package, a bottle, a lid for a bottle, a container for a non-aqueous fluid, a bucket, a bowl, a barrel, a basin, a food container, a clamshell box, a plate, a cup, a packing material a filler a foam pellet, a foam peanut, a foam sheet, a shaped foam packaging support, a medical product, an absorbent sponge, a gauze, a filament for a 3D printer, and an article formed by a 3D printer.

6. The article of claim 1, consisting essentially of:
between 50% and 75% by weight of polyvinyl alcohol;
between 5% and 15% by weight of polyethylene glycol;
between 5% and 20% by weight of talc; and
between 5% and 30% by weight of fiberglass.

7. The article of claim 1, consisting essentially of:
between 60% and 75% by weight of polyvinyl alcohol;
between 5% and 15% by weight of polyethylene glycol;
between 5% and 25% of talc; and
between 2.5% and 20% by weight of a titanium complex.

8. The article of claim 1, consisting essentially of:
fiberglass;
polyvinyl alcohol;
polyethylene glycol;
talc; and
a titanium complex.

9. A composition, comprising:
polyvinyl alcohol;
polyethylene glycol; and
a stiffener comprising one or more of talc, fiberglass, calcium carbonate, and a titanium complex.

10. The composition of claim 9, further comprising a carrier, the carrier comprising one or more of a wax, an oil, and a surfactant.

11. The composition of claim 9, wherein the composition is in a form suitable for molding, extruding, printing or otherwise forming into an article having a solid surface.

12. The composition of claim 9, consisting essentially of:
between 49.9% and 75% by weight of polyvinyl alcohol;
between 4.9% and 15% by weight of polyethylene glycol;
between 4.9% and 20% by weight of talc;
between 4.9% and 30% by weight of fiberglass; and
between 0.01% and 0.05% of a carrier selected from the group consisting of wax, oil, and surfactant,
wherein the composition is adapted to be formed into an article having at least one solid surface.

13. A method of forming an article having a solid surface, the method comprising:
modifying a shape of a composition, the composition comprising:
polyvinyl alcohol;
polyethylene glycol; and
a stiffener comprising one or more of talc, fiberglass, calcium carbonate, and a titanium complex.

14. The method of claim 13, wherein the composition consists essentially of:
between 50% and 75% by weight of polyvinyl alcohol;
between 5% and 15% by weight of polyethylene glycol;
between 5% and 20% by weight of talc; and
between 5% and 30% by weight of fiberglass.

15. The method of claim 13, wherein the composition consists essentially of:
between 60% and 75% by weight of polyvinyl alcohol;
between 5% and 15% by weight of polyethylene glycol;
between 5% and 25% of talc; and
between 2.5% and 20% by weight of a titanium complex.

16. The method of claim 13, wherein the composition consists essentially of:
fiberglass;
polyvinyl alcohol;
polyethylene glycol;
talc; and
a titanium complex.

17. The method of claim 13, wherein the composition consists essentially of:
fiberglass;
polyvinyl alcohol;
polyethylene glycol;
talc; and
a titanium complex.

18. The method of claim 13, wherein the composition consists essentially of:
between 49.9% and 75% by weight of polyvinyl alcohol;
between 4.9% and 15% by weight of polyethylene glycol;
between 4.9% and 20% by weight of talc;
between 4.9% and 30% by weight of fiberglass; and
between 0.01% and 0.05% of a carrier selected from the group consisting of wax, oil, and surfactant,
